(19) United States
(12) Patent Application Publication
(10) Pub. No.: US 2012/0222097 A1
(43) Pub. Date: Aug. 30, 2012

(54) SYSTEM AND METHOD FOR USER CLASSIFICATION AND STATISTICS IN TELECOMMUNICATION NETWORK

(76) Inventors: Jobin WILSON, Ernakulam (IN); Jayalal GOPI, Kottayam (IN); Vinod VASUDEVAN, Trivandrum (IN); Prateek KAPADIA, Kandivali (IN)

(21) Appl. No.: 13/407,440

(22) Filed: Feb. 28, 2012

(30) Foreign Application Priority Data
Feb. 28, 2011 (IN) 597/CHE/2011

(51) Int. Cl. H04L 9/32; G06N 5/00

(52) U.S. Cl. 726/5; 706/45; 726/3

(57) ABSTRACT

The embodiments herein relate to user data management in a telecommunications network and, more particularly, to classifying users in a telecommunications network and subsequently leveraging the classification and augmented statistical information. The system uses intelligent modeling techniques & machine learning algorithms to classify users. It also groups users by statistical analysis of this classification. The system is able to provide secure, authenticated and authorized access to this classification, statistical grouping and other augmented information about users to an external agent in real-time. This enables service personalization and personalized service recommendations. System allows external agents to define certain classification criteria for users in the form of models, which are pluggable in nature, to derive multiple user classification schemes. The system is also able to handle extremely large volumes of user data in the order of terabytes by scaling horizontally on inexpensive commodity hardware.

The present application is based on, and claims priority from, IN Application Number 597/CHE/2011, filed 28 Feb. 2011, the disclosure of which is hereby incorporated by reference herein.

### TECHNICAL FIELD

The embodiments herein relate to user data management in a telecommunications network and, more particularly, to classifying users in a telecommunications network and subsequently leveraging the classification and augmented statistical information.

### BACKGROUND

Telecom operators offer a large number of services and products. Users of the telecom operators, hereinafter referred to as users, have a great challenge in discovering the services and products apt for them. Service usage, interests, needs and behavior of users differ. Thus providing users with accurate service personalization and recommendations in real time is currently a challenge. Telecom operators as well as other external entities (examples of external entities include but are not limited to the telecom operators themselves, organizations wishing to advertize/market/publicize their product/process, advertising agencies, marketing agencies, public interest organizations (police, ambulance services, electricity office, water supply office and so on) and any other organization wanting to contact the user) are currently not able to take full advantage of the telecom operator's data since automatic classification and augmented statistical information of users is not available. This prevents telecom operators and their service partners from providing accurate service personalization, precise micro-targeting, customized personal offers, churn management & prediction, and service recommendations without explicitly asking users for more information. Current solutions find it challenging to provide enough contextual information relevant to a particular user and to decide on the relevance and usefulness of the content being delivered to a user.

### SUMMARY

Accordingly the Application provides a method for managing a user in a communication network, the method comprising of classifying the user in to at least one group by the continuous insight engine, based on data related to the user; assigning tags to a user by a continuous insight engine, based on the classification and augmented statistical information; and updating the classification and tags related to the user by the continuous insight engine, on receiving further data related to the user.

Embodiments also disclose a method for serving data related to a user of a communication network to at least one external entity, the method comprising of authenticating the entity by a tag serving engine, on receiving a request from the entity; fetching data related to at least one user by the tag serving engine, based on information provided by the entity; and making the fetched data available to the entity by the tag serving engine.

Also, disclosed herein is an apparatus for managing a user in a communication network, the apparatus comprising at least one means configured for classifying the user in to at least one group, based on data related to the user; assigning tags to a user, based on the classification and augmented statistical information; and updating the tags related to the user, on receiving further data related to the user.

Also, disclosed herein is an apparatus for serving data related to a user of a communication network to at least one external entity, the apparatus comprising at least one means configured for authenticating the entity, on receiving a request from the entity; fetching data related to at least one user, based on information provided by the entity; and making the fetched data available to the entity.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This Application is illustrated in the accompanying drawings, through out which like reference letters indicate corresponding parts in the various figures. The embodiments herein will be better understood from the following description with reference to the drawings, in which:

FIG. 1 illustrates a system diagram for classification of the user, according to embodiments as disclosed herein;

FIG. 2 depicts a data uploader engine, according to embodiments as disclosed herein;

FIG. 3 depicts a Continuous Insight Engine, according to embodiments as disclosed herein;

FIG. 4 depicts Model Scheduler Module, according to embodiments as disclosed herein;

FIG. 5 depicts Tag serving engine, according to embodiments as disclosed herein;

FIG. 6 is a flow chart displaying the process involved in how a classified user information is provided to a requesting entity, according to embodiments as disclosed herein;

FIG. 7 is a flow chart displaying the process involved in how new data are stored and queued for processing, according to embodiments as disclosed herein;

FIG. 8 is a flow chart depicting the process of classification, according to embodiments as disclosed herein;

FIG. 9 is a flow chart displaying the process involved in how tags are assigned to individual users, according to embodiments as disclosed herein; and

FIG. 10 is a flow chart displaying the process involved in how information about classified users are provided to requesting advertising companies, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

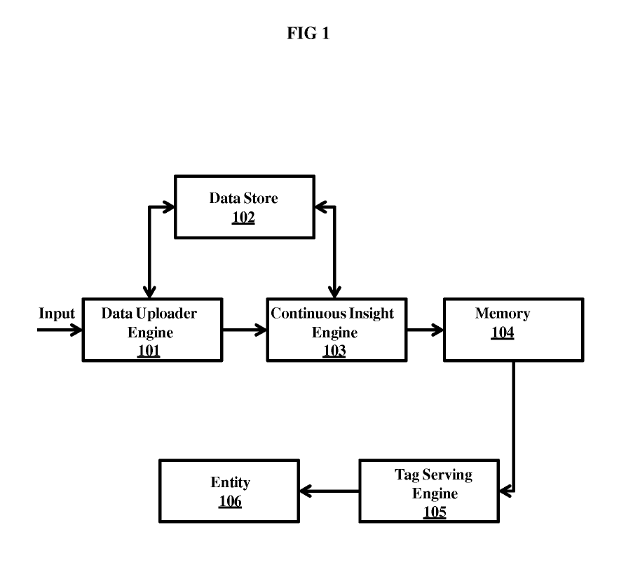

The embodiments herein achieve a solution for classifying the user by analyzing its interactions with network and value added service and with other users by providing systems and methods thereof. Referring now to the drawings, and more particularly to FIGS. 1 through 9, where similar reference characters denote corresponding features consistently throughout the figures, there are shown preferred embodiments.

Embodiments disclosed herein utilize various models to arrive at user classification based on the data provided, wherein the models use mathematical analysis to derive patterns and trends that exist in data. To detect such patterns, distributed systems capable of analyzing complex relationships within extremely large data volumes are used.

A system and method for classifying users by analyzing the interaction of the users with the network, value added services and with other users is disclosed herein. The system automatically extracts insights about users through modeling techniques, supervised and unsupervised machine learning and statistical techniques. On classifying the users, embodiments herein also provide classification, statistical grouping of users and other augmented information about the user to an external entity via an application programming interface (API). The external entity may be an organization desiring to target specific customers or the telecom operator itself for personalizing its user's experience across touch points. Examples of external entities include but are not limited to the telecom operators themselves, organizations wishing to advertize/market/publicize their product/process, advertising agencies, marketing agencies, public interest organizations (police, ambulance services, electricity office, water supply office and so on) and any other organization wanting to contact the user. The external entity could even be an OTT application that requires real time access to a user classification. The system allows the external entity to define certain classification criteria for segmenting users. The system includes authentication and authorization mechanisms for the telecom operator to regulate access to its service partners. The method enables the entity to provide services personalized and recommended based on users' preferences and behavior learned by the system. Further, embodiments disclosed herein enables handling of extremely large volumes of users' data in the order of terabytes by scaling horizontally on inexpensive commodity hardware. Furthermore, the system and method store and serve insights with extremely low latency. Embodiments herein provide flexibility to plug-in multiple models easily to generate different types of insights, which may be derived using different statistical or machine learning algorithms.

FIG. 1 illustrates a system diagram for classification of the user, according to embodiments as disclosed herein. When the input data arrives at the telecom operator network, the Data Uploader Engine 101 fetches the information. The data uploader engine 101 may check the telecom operator network for data at pre-specified intervals and fetch the data from the telecom operator network, where the intervals may be specified by the administrator or the telecom operator network. The data uploader engine 101 may also fetch the data from the telecom operator network as soon as the data is received at the telecom operator network. The telecom operator network may also push the data to the data uploader engine 101 at pre-specified intervals. The telecom operator network may push the data to the data uploader engine 101 on receiving at least some data related to at least one user. The telecom operator network may also push real-time updates for mobility and location related data feeds which require real time integration. After fetching the data, the data uploader engine 101 may store the data in a Data Store (which could be a Relational Database Management System (RDBMS) or Distributed File System or Key-Value Store) 102 for future use. The data may be data received from a telecom network operator and may comprise of the activities of the user including the Value Added Services (VAS) accessed by the user, the location of the user, the most frequent locations visited by the user and any other data from the user which may be used to categorize the user. The received data is also passed to a Continuous Insight Engine 103 by the data uploader engine 101. The Continuous Insight Engine 103 provides data dependency management & scheduling capabilities by which the data processing workflow applications would be triggered only if the data dependency is met at the scheduled time. On receiving data from the data uploader engine 101, the continuous insight engine 103 checks if the received data is relevant for the user. The continuous insight engine 103 may check if the received data may be used to refine the classification of the user to whom the received data pertains. The continuous insight engine 103 may check if the received data pertains to a user who has not been classified into a category as yet and may be classified based on the received data. If the received data is not sufficient to classify the user, the continuous insight engine 103 may store the data and wait for more data about the user and then classify based on the previously received data and the new data. This data may then be stored in distributed memory 104. Data is organized in a distributed memory for subsequent processing to generate user classifications which subsequently get persisted in a high performance tag store. The memory may be implemented as a distributed file system which provides high availability, fault tolerance & scalability using data replication technique. A suitable distributed file system such as Hadoop Distributed File System (HDFS) may be used as the underlying distributed file system. Data arriving into the distributed memory 104 is processed in a distributed fashion by an underlying framework which provides a workflow based interface. It may be based on Oozie or any suitable workflow engine which can manage data processing jobs for a distributed system and can perform extensible, scalable and data-aware services to orchestrate dependencies between jobs running on the distributed system. User classification and augmented statistical information generated from workflow applications deployed in the continuous insight engine 103 gets persisted into a distributed tag store with low latency read & write capabilities. The continuous insight engine 103 may augment the classification using predictive modeling, wherein the classification is augmented with additional attributes such as confidence measures. Confidence measure enhances the predictive angle to the classification and represents a degree of algorithmic confidence that the model has on the specific classification. The continuous insight engine 103 may also associate attributes with the tags, for example, timestamps, tag families and so on. The timestamp represents the time when the classification was performed. The tag family may represent the logical grouping to which the tag belongs. User classification and augmented statistical information in the form of tags are retrieved through the Tag Serving engine 105. The tags may be retrieved using REST/SOAP protocols over HTTP/HTTPS protocols and the user classification is provided for the entity 106 upon receiving a request from the entity 106. The data exposed to the entity 106 may depend on the access level authorized for the entity 106. For example, an entity may be subscribed to receiving all information related to the user such as full name, complete address, most frequented locations, age, date of birth and so on; while another entity may be subscribed to receiving only basic information about the user such as his age band, city and so on.

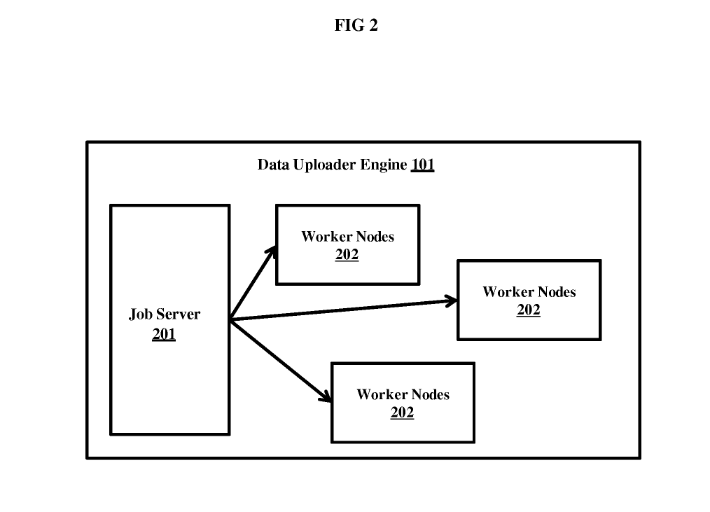

FIG. 2 depicts a data uploader engine 101, according to embodiments as disclosed herein. When the input data arrives at the telecom operator network, the Data Uploader Engine 101 fetches the information. The data uploader engine 101 may check the telecom operator network for data at pre-specified intervals and fetch the data from the telecom operator network, where the intervals may be specified by the administrator or the telecom operator network. The data uploader engine 101 may also fetch the data from the telecom operator network as soon as the data is received at the telecom operator network. The job server 201 receives the data files. These data files could be large and copying them would consume time. Therefore, each data source will be processed by at least one worker node machine 202. In case, a worker node fails, then the data source will be handled by another active worker node through a task re-allocation. The worker node machine 202 may be selected dynamically by the master job server 201 based on the current workload on the worker node machines 202. This operation may be performed in a distributed fashion. There are provisions to integrate real time data sources as well into the system by using the data stream automation interface. The Data Uploader Engine 101 may fetch the data file(s), uncompress if needed, merge them and copy them to a distributed file system partitioned by date.

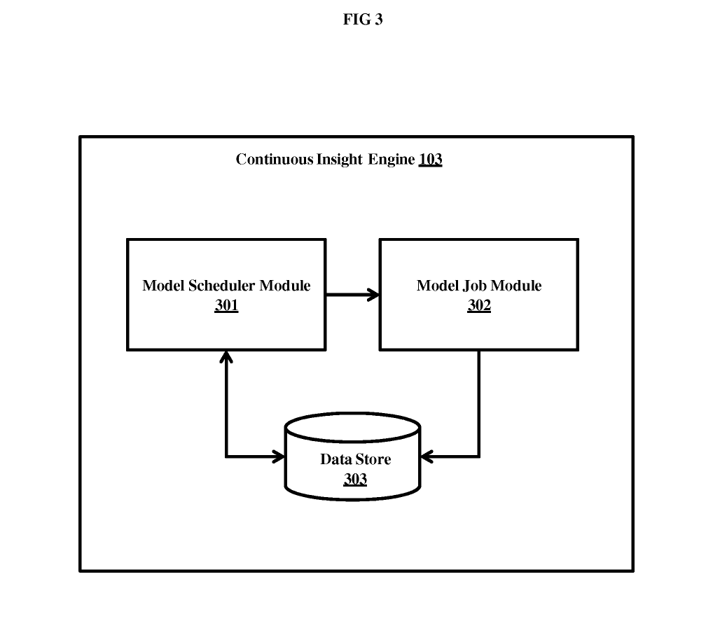

FIG. 3 depicts a Continuous Insight Engine 103, according to embodiments as disclosed herein. The Continuous Insight engine 103 comprises of a Model Scheduler module 301 which supports data dependency management and scheduling capabilities by which the data processing workflow applications are triggered only if the data dependency is met at the scheduled time. On receiving data from the data uploader engine 101, the Model Scheduler module 301 checks if the received data is relevant for the user. The Model Scheduler module 301 may check if the received data may be used to refine the classification of the user to whom the received data pertains. The Model Scheduler module 301 may check if the received data pertains to a user who has not been classified into a category as yet and may be classified based on the received data. If the received data is not sufficient to classify the user, the Model Scheduler module 301 may store the data and wait for more data about the user and then classify based on the previously received data and the new data. This data may then be stored in distributed memory 104. The Model Scheduler module 301 is linked to the Data Store 303. The Data Store 303 contains model meta-data which are in the queue and engine configuration information. The data satisfying the data dependency criteria are passed to the model job module 302. The data dependency criterion depends on real-time capabilities i.e. receiving the correct data in specified interval of time. The model job module 302 receives the data through model job server and performs operations on it in a distributed fashion over worker nodes to ensure parallelism and load balancing. Model job scheduler 302 ensures that the job is distributed evenly over worker nodes. In case, if any of the worker node fails, the tasks are reallocated to other functional worker nodes. This is achieved by utilizing map-reduce capabilities. These worker nodes generate intermediate files which are passed back to the model job server. The model job server assigns tags to the user. Information about the processed data is communicated to the Data Store 303. The Data Store 303 on receiving the information about the processed data may remove the data from the queue.

The continuous insight engine 103 processes data in a distributed fashion by an underlying framework which provides a workflow based interface. The distributed nature of the continuous insight engine 103 allows it to scale horizontally to cater to extremely large volumes of data as well as to complex processing logic requirements. Custom workflow applications can be developed within the continuous insight engine 103, using a set of actions capable of executing in a distributed fashion within a cluster of nodes. Examples of such actions are scripting action (PIG scripts), SQL action (Hive operations), Shell action (shell commands), Java action (triggering java operations), Map-Reduce actions (triggering Map-Reduce operations) and so on. Custom interfaces could be built to have domain specific programming language with a workflow interface. The continuous insight engine 103 supports data dependency management & scheduling capabilities by which the data processing workflow applications would be triggered only if the data dependency is met at the scheduled time. A concept of “wait for data” is also implemented in the continuous insight engine 103 where in applications would wait for a certain configurable period of time to see if data dependency is met. Applications will have a nominal time (when they are scheduled to run) as well as an actual time (if the data dependency gets met before timeout occurs) for execution.

The Continuous Insight Engine 103 further comprises a pluggable model interface such that multiple models may be created and dynamically plugged-in to the Continuous Insight Engine 103 to perform classification using multiple schemes as well as to extend or improve an existing classification scheme within the Continuous Insight Engine 103. The Continuous Insight Engine 103 is configured for supporting co-existence of models and limits the impact of changes to models to only those classifications/tags which utilize the model rather than the entire engine. The basic philosophy here is to provide run-time flexibility to selectively modify models or parts of models with no impact to the rest of the engine. This pluggability is achieved through an underlying workflow engine (such as Oozie) which uses a domain specific language in XML. Each of the steps within a model would be implemented as a workflow action and the jobs which perform user classification could invoke these actions in any desired order. This approach enables multiple custom actions or multiple versions of custom actions to co-exist in the system and the analyst could plug-in the required set of actions as necessary for the desired classification scheme that suits his need without impacting other classification schemes.

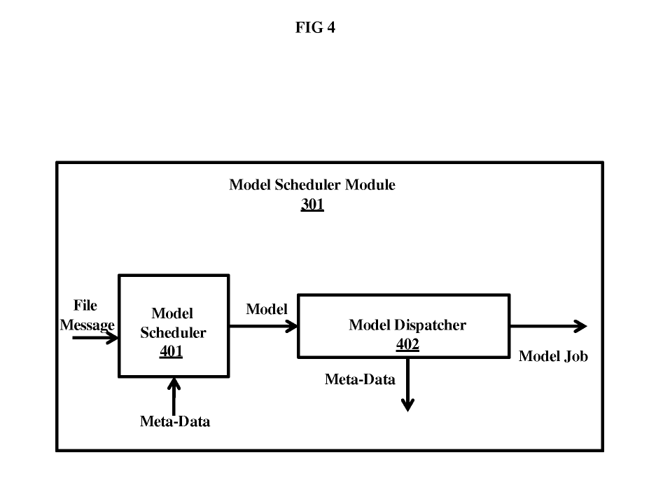

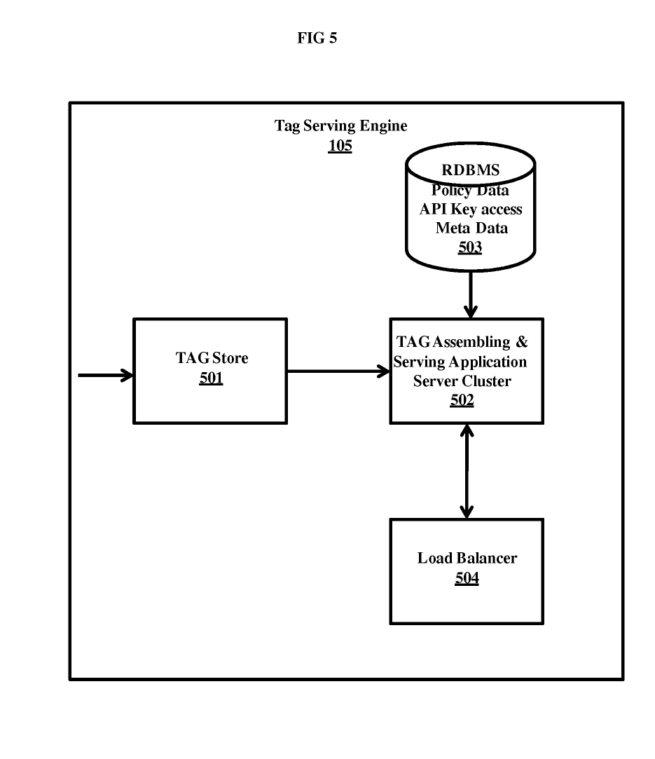

FIG. 4 depicts Model Scheduler Module 301, according to embodiments as disclosed herein. File messages passed by the data uploader engine 101 are received by the model scheduler 401. The model scheduler 401 supports data dependency management and scheduling capabilities by which the data processing workflow applications are triggered only when the data dependency is met at the scheduled time. The model scheduler 401 receives meta-data from Data Store 303. A concept of “wait for data” is also implemented in model scheduler 401 where in applications wait for a certain configurable period of time to check if data dependency is met. Applications will have a nominal time if they are scheduled to run and an actual time if the data dependency is met before timeout occurs for execution. Once the data dependency is met the model is queued in the model dispatcher 402. The model dispatcher 402 dispatches the model job to the model job module 302 and also passes the meta-data information to the Data Store 303.

FIG. 5 depicts Tag serving engine, according to embodiments as disclosed herein. User classification and augmented statistical information gets stored in a distributed tag store 501 with low latency read & write capabilities. The distributed tag store may be based on HBase or similar kind of non-relational, distributed database model which provides a fault-tolerant way of storing large quantities of sparse data. Data is replicated across multiple nodes for high availability. This store is highly scalable and is capable of handling terabytes of data using commodity hardware. User classification and augmented statistical information in the form of tags can be consumed by touch point systems using simple REST/SOAP protocols over HTTP/HTTPS protocols. Tag assembling and serving application server cluster 502 provides the user information to the requesting party. The requesting party may also request the information using a browser and an internet connection. The request made by a requesting party to access the tag information of users, is passed through a load balancer 504. Load balancer 504 will distribute the load/request on several worker nodes. Custom Application Programming Interface (API) key provided in RDBMS 503 is implemented for retrieving tags from the tag store. Authentication and Authorization is handled by API key access. An API key based access policy is implemented where in a particular API key would have access to a certain group of tag(s). API Keys are tied to specific touch point IP addresses, which means, a key would be valid only if used from a designated IP address. This ensures that keys can be used by only legitimate and authorized touchpoints. This enables different downstream systems and service partners to have access to only the insights that they are eligible to view.

Subscriber classification and augmented statistical information generated from model jobs deployed in the continuous insight engine 103 gets persisted in the tag store 501 with low latency read & write capabilities (which may be HBase based). Data is replicated across multiple nodes for high availability. This store is highly scalable NoSQL based & is capable of handling terabytes of data using commodity hardware. The tag serving engine 105 also has capabilities to automatically measures the response time and increases/decreases the number of instances, dynamically in response to increase/decrease in response time so as to provide optimum low latency data access.

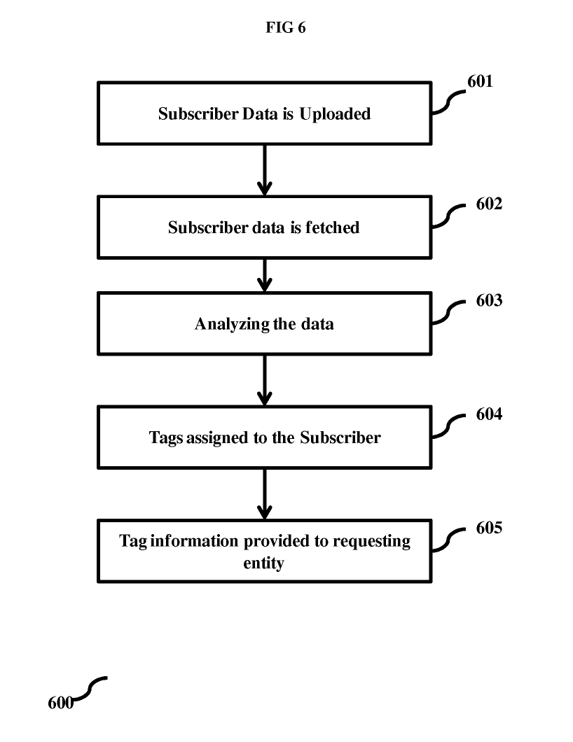

FIG. 6 is a flow chart displaying the process involved in how classified user information is provided to a requesting entity, according to embodiments as disclosed herein. The large raw data sets and transaction logs of users are uploaded (601) in Data Uploader engine 101. All the information regarding a user is stored on a distributed file system. The data meeting the data dependency spread over the distributed file system are fetched (602) and analyzed (603). Depending on the user behavior derived from the data stored, tags are assigned (604) to users and these tags are stored (605) in a distributed tag store 501. These tags are assembled and the tag information is provided (605) to authenticated and authorized requesting entities. The various actions in method 600 may be performed in the order presented, in a different order or simultaneously. Further, in some embodiments, some actions listed in FIG. 6 may be omitted.

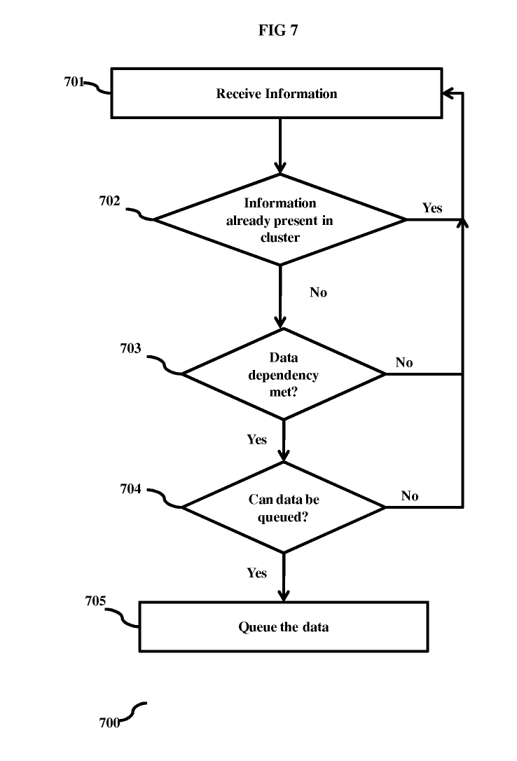

FIG. 7 is a flow chart displaying the process involved in how new data are stored and queued for processing, according to embodiments as disclosed herein. The user information is received (701) by the data uploader engine 101. The information received is checked (702) if it is already present in the cluster. If the information is present in the cluster then the data uploader engine 101 discards that information and waits until it receives fresh/new information. Once the data uploader engine 101 receives fresh/new information, the data uploader engine 101 checks (703) if the information meets data dependency. A data dependency criterion depends on real time issues. The correct data should be received in specified time period. If the data dependency is not met for the data, the data is discarded by the data uploader engine 101 and the data uploader engine 101 waits again to receive the information. Whereas, if the data dependency is met, the data is checked (704) by the data uploader engine 101 if it can be queued. Queuing of a data is possible only if its meta-data are available along with the resources for its execution. If the data cannot be queued, the data is discarded by the data uploader engine 101 and the data uploader engine 101 waits again to receive the information. Whereas, if data can be queued, the data is put (705) into the queue by the data uploader engine 101 for the execution. The various actions in method 700 may be performed in the order presented, in a different order or simultaneously. Further, in some embodiments, some actions listed in FIG. 7 may be omitted.

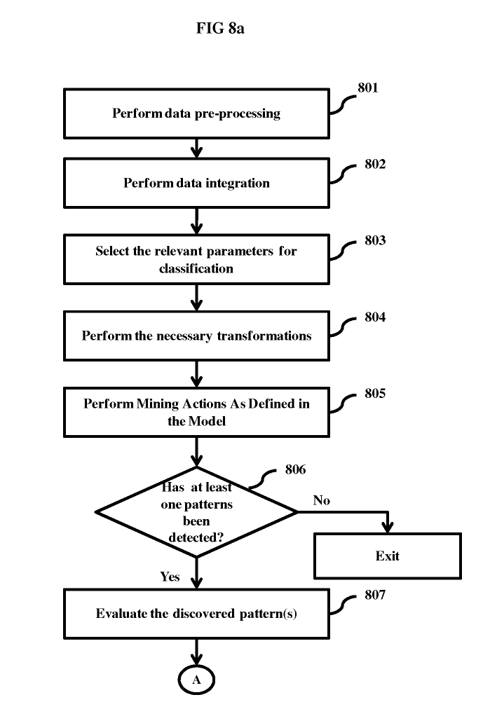

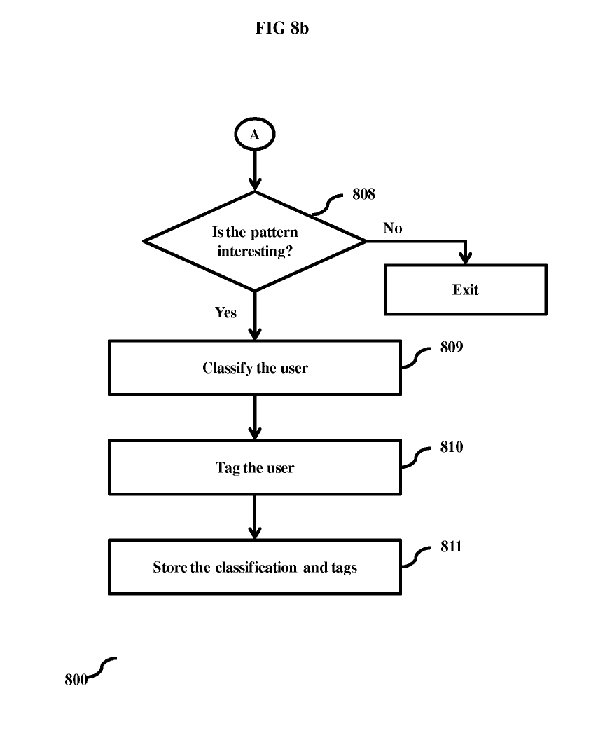

FIG. 8 is a flow chart depicting the process of classification, according to embodiments as disclosed herein. On receiving the data, the continuous insight engine 103 performs (801) data pre-processing to eliminate noise and data inconsistencies. Further, the continuous insight engine 103 performs (802) data integration, wherein the received data is integrated with data from other data sources (which may be taken from external or internal sources). The continuous insight engine 103 may also integrate the received data with existing data from the data store 102. The continuous insight engine 103 selects (803) the relevant attributes from the data. The selected attributes depend on the classification scheme being used. The continuous insight engine 103 then performs (804) the necessary transformations to prepare the data for classification, which may comprise of but not be limited to normalization. The continuous insight engine 103 performs (805) data mining actions as defined in the model to identify interesting patterns within the data. The continuous insight engine 103 may use at least one suitable algorithm which may comprise of but not be limited to clustering, classification, collaborative filtering and so on. If the continuous insight engine 103 detects (806) at least one pattern, the continuous insight engine 103 evaluates (807) the pattern(s) for interestingness in terms of the pattern being sufficient to perform classification. The continuous insight engine 103 may use suitable statistical properties of the patterns. If the pattern is interesting (808), the continuous insight engine 103 classifies (809) and tags (810) the user based on the pattern. Further, the continuous insight engine 103 stores (811) the classification and tags in the data store 102. In another embodiment herein, the classification may be augmented with additional statistical information. The various actions in method 800 may be performed in the order presented, in a different order or simultaneously. Further, in some embodiments, some actions listed in FIG. 8 may be omitted.

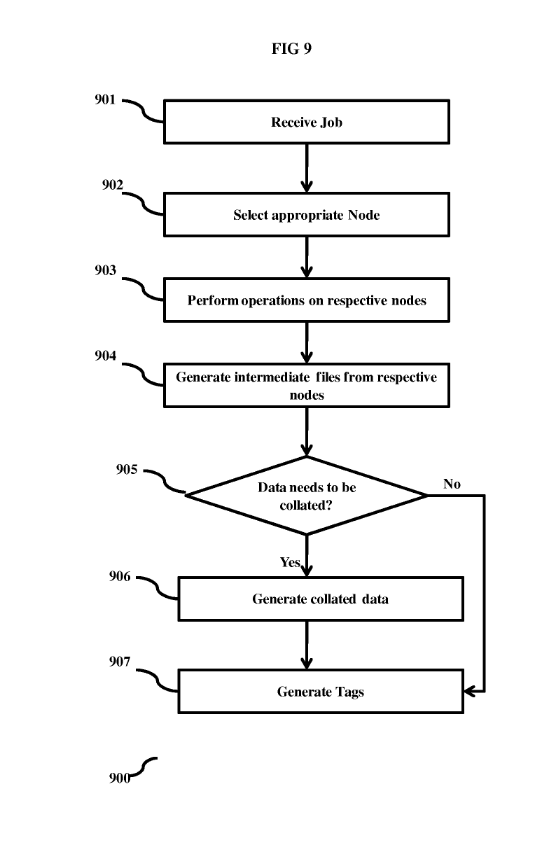

FIG. 9 is a flow chart displaying the process involved in how tags are assigned to individual users, according to embodiments as disclosed herein. The data appended in the queue for execution are dispatched to the job server via the model dispatcher 402. The job server in the continuous insight engine 103 receives (901) the job for execution. These jobs are distributed over various worker nodes by selecting (902) appropriate node to execute based on the data locality and proximity. The operations are performed (903) on these data by the respective nodes which generate (904) intermediate files from their respective nodes which are checked (905) if they need to be collated. Tags are generated (907) if the generated files do not require collation. Whereas generated files are collated (906) if the generated files need to be collated before generating the classification in the form of tags. The various actions in method 900 may be performed in the order presented, in a different order or simultaneously. Further, in some embodiments, some actions listed in FIG. 9 may be omitted.

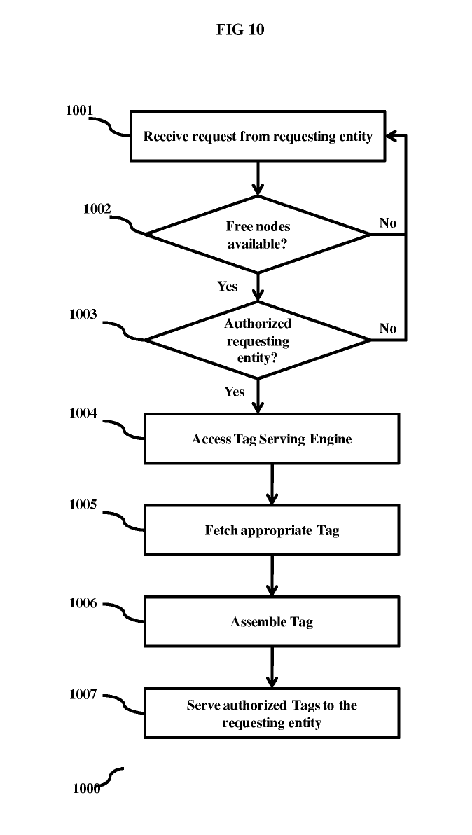

FIG. 10 is a flow chart displaying the process involved in how information about classified users are provided to a requesting entity, according to embodiments as disclosed herein. A request is received (1001) from the requesting entity requesting access to user information. Arriving requests are passed to the load balancer 504. The load balancer 504 checks (1002) if there are any free worker nodes available to handle the request. If no worker nodes are available, the request is declined whereas if the nodes are free, the request is handled. To perform the request, requesting entity is checked (1003) for its authentication and its authorization to access the tag information. If the requesting entity is not an authenticated member, its request is declined. But if the requesting entity is an authenticated and authorized member, then it is allowed (1004) to access the designated set of Tags 904. Appropriate Tags are fetched (1005) from the tag store as per the request of the requesting entity, assembled (1006) and is made available (1007) to the requesting entity through the tag serving engine. The various actions in method 1000 may be performed in the order presented, in a different order or simultaneously. Further, in some embodiments, some actions listed in FIG. 10 may be omitted.

The embodiments herein relate to user data management in a telecommunications network and, more particularly, to classifying users in a telecommunications network and subsequently leveraging the classification and augmented statistical information to personalize user's experience across touch points (operator's as well as external entity's) as well as enabling advertisers and OTT applications to deliver precise, micro-targeted campaigns with high contextual relevance. The system uses intelligent modeling techniques & machine learning algorithms to classify users by analyzing the user's interactions with network and value-added services, and with other users. It also groups users by statistical analysis of this classification. The system is able to provide secure, authenticated and authorized access to this classification, statistical grouping and other augmented information about users to an external agent via an application programming interface. This enables service personalization and personalized service recommendations based on user's preferences & behavior learned by the system. System allows external agents to define certain classification criteria for users in the form of models, which are pluggable in nature, to derive multiple user classification schemes. The system is also able to handle extremely large volumes of user data in the order of terabytes by scaling horizontally on inexpensive commodity hardware. The system allows configuration changes for model jobs to allow alterations to the sequence of actions, versions of the actions, recurrence, time of execution as well as additional model job level configuration parameters.

The embodiments disclosed herein can be implemented through at least one software program running on at least one hardware device and performing network management functions to control the network elements. The network elements shown in FIGS. 1, 2, 3, 4 and 5 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for managing a user in a communication network, said method comprising of
Classifying said user in to at least one group by said continuous insight engine, based on data related to said user;
Assigning tags to a user by a continuous insight engine, based on said classification; and
Updating said classification and tags related to said user by said continuous insight engine, on receiving further data related to said user.

2. The method, as claimed in claim 1, wherein said continuous insight engine receives data using at least one of
Fetching said data from said communication network by said continuous insight engine at pre-specified intervals;
Fetching data from said communication network by said continuous insight engine as soon as said data becomes available at said communication network;
Pushing data by said communication network to said continuous insight engine at pre-specified intervals; and
Pushing data by said communication network to said continuous insight engine as soon as said data becomes available at said communication network.

3. The method, as claimed in claim 1, wherein classifying said user further comprises of
Performing data pre-processing on said data by said continuous insight engine;
Selecting at least one relevant parameter for classification from said data by said continuous insight engine;
Performing data mining actions on said data for detecting at least one pattern in said data by said continuous insight engine;
Evaluating said at least one pattern for interestingness by said continuous insight engine; and
Classifying said user based on said at least one pattern by said continuous insight engine.

4. The method, as claimed in claim 3, wherein said classification is specified by at least one of
Operator of said communication network; or
An external entity

5. The method, as claimed in claim 3, wherein said data is integrated with at least one other source of data by said continuous insight engine.

6. The method, as claimed in claim 3, wherein classifying said user further comprises of augmenting classification with additional statistical information by said continuous insight engine.

7. The method, as claimed in claim 1, wherein said continuous insight engine stores said data in a distributed file system.

8. The method, as claimed in claim 1, wherein said continuous insight engine checks for relevance of said data before using said data.

9. The method, as claimed in claim 1, wherein said continuous insight engine checks for sufficiency of said data before using said data.

10. The method, as claimed in claim 1, wherein said continuous insight engine comprises of a plurality of distributed cluster of nodes.

11. The method, as claimed in claim 1, wherein said method further comprises of said continuous insight engine's behavior being modified dynamically.

12. A method for serving data related to a user of a communication network to at least one external entity, said method comprising of
Authenticating said entity by a tag serving engine, on receiving a request from said entity;
Fetching data related to at least one user by said tag serving engine, based on information provided by said entity; and
Making said fetched data available to said entity by said tag serving engine.

13. The method, as claimed in claim 12, wherein said tag serving engine authenticates said entity using an Application Programming Interface (API) based access key.

14. The method, as claimed in claim 12, wherein said tag serving engine searches for data related to at least one user based on tags assigned to said user.

15. The method, as claimed in claim 12, wherein said tag serving engine automatically measures response time and increases/decreases the number of instances, dynamically in response to increase/decrease in response time.

16. The method, as claimed in claim 12, wherein said tag serving engine performs load balancing on receiving said request from said entity.

17. The method, as claimed in claim 12, wherein said tag serving engine makes said fetched data available to said entity based on a level assigned to said entity.

18. An apparatus for managing a user in a communication network, said apparatus comprising at least one means configured for
Classifying said user in to at least one group, based on data related to said user;
Assigning tags to a user, based on said classification; and
Updating said tags related to said user, on receiving further data related to said user.

19. The apparatus, as claimed in claim 18, wherein said apparatus is configured for receiving data using at least one of
Fetching said data from said communication network at pre-specified intervals;
Fetching data from said communication network as soon as said data becomes available at said communication network;
Pushing data by said communication network at pre-specified intervals; and
Pushing data by said communication network as soon as said data becomes available at said communication network.

20. The apparatus, as claimed in claim 18, wherein said apparatus is configured for classifying said user by
Performing data pre-processing on said data;
Selecting at least one relevant parameter for classification from said data;
Performing data mining actions on said data for detecting at least one pattern in said data;
Evaluating said at least one pattern for interestingness; and
Classifying said user based on said at least one pattern.

21. The apparatus, as claimed in claim 20, wherein said apparatus is configured for enabling at least one of
Operator of said communication network; or
An external entity;
To specify said classification.

22. The apparatus, as claimed in claim 20, wherein said apparatus is configured for integrating said data with at least one other source of data.

23. The apparatus, as claimed in claim 20, wherein said apparatus is configured for classifying said user by augmenting classification with additional statistical information.

24. The apparatus, as claimed in claim 18, wherein said apparatus is configured for storing said data in a distributed file system.

25. The apparatus, as claimed in claim 18, wherein said apparatus is configured for checking for relevance of said data before using said data.

26. The apparatus, as claimed in claim 18, wherein said apparatus is configured for checking for sufficiency of said data before using said data.

27. The apparatus, as claimed in claim 18, wherein said apparatus comprises a plurality of distributed cluster of nodes, wherein additional nodes are added in a dynamic manner.

28. The apparatus, as claimed in claim 27, wherein said additional nodes are configured for auto synchronizing with existing model job configurations.

29. The apparatus, as claimed in claim 18, wherein said apparatus' behavior being modified dynamically

30. An apparatus for serving data related to a user of a communication network to at least one external entity, said apparatus comprising at least one means configured for
Authenticating said entity, on receiving a request from said entity;
Fetching data related to at least one user, based on information provided by said entity; and
Making said fetched data available to said entity.

31. The apparatus, as claimed in claim 30, wherein said apparatus is configured for authenticating said entity using an Application Programming Interface (API) based access key.

32. The apparatus, as claimed in claim 30, wherein said apparatus is configured for searching for data related to at least one user based on tags assigned to said user.

33. The apparatus, as claimed in claim 30, wherein said apparatus is configured for automatically measuring response time and increases/decreases the number of instances, dynamically in response to increase/decrease in response time.

34. The apparatus, as claimed in claim 30, wherein said apparatus is configured for performing load balancing on receiving said request from said entity.

35. The apparatus, as claimed in claim 30, wherein said apparatus is configured for making said fetched data available to said entity based on a level assigned to said entity.
